(19) United States
(12) Patent Application Publication
(10) Pub. No.: US 2013/0188915 A1
(43) Pub. Date: Jul. 25, 2013

(54) PLASTIC OPTICAL FIBER UNIT AND PLASTIC OPTICAL FIBER CABLE USING SAME

(71) Applicant: ASAHI GLASS COMPANY, LIMITED, Tokyo (JP)

(72) Inventor: Osakazu KIMOTO, Tokyo (JP)

(73) Assignee: ASAHI GLASS COMPANY, LIMITED, Tokyo (JP)

(21) Appl. No.: 13/792,834

(22) Filed: Mar. 11, 2013

Related U.S. Application Data
(63) Continuation of application No. PCT/JP2011/070299, filed on Sep. 6, 2011.

(30) Foreign Application Priority Data
Sep. 13, 2010 (JP) 2010-204243

(51) Int. Cl. G02B 6/44

(52) U.S. Cl. CPC G02B 6/443
USPC 385/102

(57) ABSTRACT

The present invention relates to a plastic optical fiber unit in which a plurality of plastic optical fibers each comprising an optical fiber body and a reinforcing layer covering an outer circumference of the optical fiber body is bundled in a longitudinal direction and integrated, and a coating resin is applied so as to cover the entire bundle of the plastic optical fibers, in which the plastic optical fiber unit satisfies the relationship of 0.15≦T/D≦0.50 when a thickness of the reinforcing layer of the plastic optical fiber is D and a shortest distance of from the plastic optical fiber to the outer circumference of the plastic optical fiber unit is T.

### TECHNICAL FIELD

The present invention relates to a plastic optical fiber unit constituted of a plurality of plastic optical fibers, and a plastic optical fiber cable using the same.

### BACKGROUND ART

Optical fibers used as large-capacity communication media are classified roughly into Silica Glass Optical Fiber and Plastic Optical fiber (hereinafter sometimes referred to as “POF”). Of those, the plastic optical fiber is flexible and does not break as compared with the silica glass optical fiber. Furthermore, the plastic optical fiber has large core diameter and therefore is excellent in works such as terminal treatment. For this reason, the plastic optical fiber has been used widely in various uses. Particularly, graded index type (refractive index distribution type) plastic optical fiber (hereinafter sometimes referred to as “GI-POF”), which has distribution in refractive index in a cross-sectional direction, has high-speed and large-capacity transmission capability, and is therefore expected as an optical fiber in next-generation communications.

Optical fiber is impractical in a bare form, and from the necessities of protection of optical fiber, multicore, connector attachment and the like, is used in a cable form by applying a covering to an optical fiber, or combining with a fiber tension member such as an aramid fiber, or a steel wire, or the like.

Example of a plastic optical fiber cable or cord for communication, which has a plastic optical fiber and a fiber tension member, includes one described in Patent Document 1. This discloses a plastic optical fiber cord in which a slit is formed in a resin-made tube in an axial direction to form cleavage, a plastic optical fiber is inserted from the cleaved portion, a fiber tension member is arranged on the outer circumference of the thus-obtained optical fiber-containing cleaved tube, and a jacket tube is extrusion-molded so as to cover their outer circumferences. Further, there is described that an aramid fiber is used as the tension member.

Furthermore, for example, Patent Document 2 describes a cable using an integrated aggregate in which a plurality of plastic optical fibers and a tension member are bundled such that they are brought into contact with each other at two or more positions in a cross-sectional direction and a tape-like material or a thread-like material is wound around the bundle.

Furthermore, for example, Patent Document 3 describes that a plurality of plastic optical fibers are gathered in a bundle form and it is covered with an ultraviolet light-curable resin.

However, in the case that a fiber tension member is arranged on the outer circumference of the cleaved tube having POF inserted therein and a jacket tube is extrusion-molded so as to cover their outer circumferences as described in Patent Document 1, there were the problems that production step of a cleaved tube becomes necessary and an outer diameter of a cable is increased by the use of a cleaved tube.

Furthermore, it is known in an optical fiber that microbending loss is rapidly increased with increasing a core diameter and reducing a fiber diameter (see Non-Patent Document 1).

POF is plastic. Therefore, core diameter/clad diameter, and fiber outer diameter can easily be changed, and a fiber having a core diameter larger than that of a silica glass optical fiber can easily be produced. However, where balance between core diameter/clad diameter and fiber outer diameter breaks down, countermeasures are required to improve lateral pressure resistance characteristic and to inhibit occurrence of microbending. Therefore, in small diameter GI-POF, there is a problem that when a plurality of fibers are bundled with a tape or the like as described in Patent Document 2, transmission loss is increased by lateral pressure and microbending when the tape has been wound.

Furthermore, in plastic optical fibers merely covered with an ultraviolet light-curable resin as described in Patent Document 3, there is a problem that transmission loss of plastic optical fibers is increased during the production of a plastic optical fiber unit unless the relationship between a thickness of a fiber reinforcing layer and a coating thickness is appropriately adjusted, and a problem that transmission loss after forming a cable using the plastic optical fiber unit is increased.

In recent years, from the standpoints of handling properties and design, reducing in diameter of an optical cable has been advanced, and need of POF units packaged in higher density than in the past has been expanded. To achieve small diameter of a cable and high density packaging of POF, need to reduce an outer diameter of POF has arisen. In the case that only an outer diameter of POF is reduced in the state of maintaining a large core diameter that is a merit of POF, the conventional structure had the problem that lateral pressure resistance and microbending resistance characteristic of POF are decreased and light loss of a cable using the POF does not stabilize.

### RELATED ART

### Patent Document

Patent Document 1: WO2004/107004

Patent Document 2: WO2004/102244

Patent Document 3: JP-A-2009-98342

### Non-Patent Document

Non-Patent Document 1: R. Olshansky, APPLIED OPTICS Vol. 14, 1975, pp20-21.

### SUMMARY OF THE INVENTION

### Problems that the Invention is to Solve

To solve the above-described problems in the prior arts, the present invention has an object to provide a plastic optical fiber unit in which fibers are protected from lateral pressure due to the formation of a cable in a POF unit packaged in high density and occurrence of microbending generated by, for example, the contact with cable structural members, and a plastic optical fiber cable using the same.

### Means for Solving the Problems

In order to achieve the above object, the present invention provides a plastic optical fiber unit in which a plurality of plastic optical fibers each comprising an optical fiber body and a reinforcing layer covering an outer circumference of the optical fiber body is bundled in a longitudinal direction and integrated, and a coating resin is applied so as to cover the entire bundle of the plastic optical fibers, in which the plastic optical fiber unit satisfies the relationship of 0.15≦T/D≦0.50 when a thickness of the reinforcing layer of the plastic optical fiber is D and a shortest distance of from the plastic optical fiber to the outer circumference of the plastic optical fiber unit is T.

It is preferred in the plastic optical fiber unit according to the present invention, that the coating resin is an ultraviolet light-curable resin or an electron beam-curable resin, and has Young's modulus at ordinary temperature (23° C.) after curing of from 90 to 1,000 MPa.

The plastic optical fiber unit according to the present invention preferably has a cross-section of nearly circular form or nearly elliptical form.

In the plastic optical fiber unit according to the present invention, the optical fiber body is preferably a graded index type plastic optical fiber.

In the plastic optical fiber unit according to the present invention, it is preferred that the optical fiber body is a graded index type plastic optical fiber, the plastic optical fiber has at least two layers of clad layers, and a refractive index of an outer circumferential clad layer is lower than a refractive index of an inner clad layer.

Further, the present invention provides a plastic optical fiber cable using the plastic optical fiber unit of the present invention.

### Advantage of the Invention

According to the present invention, a plastic optical fiber cable in which lateral pressure characteristic and microbending characteristic are improved and plastic optical fibers having stable transmission loss are packaged in high density can be provided.

### BRIEF DESCRIPTION OF THE DRAWINGS

FIG. 1 is a cross-sectional view showing one embodiment of the plastic optical fiber unit of the present invention.

FIG. 2 is a cross-sectional view showing another embodiment of the plastic optical fiber unit of the present invention.

FIG. 3 is a cross-sectional view showing one embodiment of a plastic optical fiber cable using the plastic optical fiber unit of the present invention.

FIG. 4 is a cross-sectional view showing another embodiment of a plastic optical fiber cable using the plastic optical fiber unit of the present invention.

FIG. 5 is a cross-sectional view showing still another embodiment of a plastic optical fiber cable using the plastic optical fiber unit of the present invention.

FIG. 6 is a cross-sectional view showing one embodiment of the conventional plastic optical fiber cable.

### MODE FOR CARRYING OUT THE INVENTION

The plastic optical fiber cable of the present invention is described in detail below by reference to the drawings.

FIG. 1 is a cross-sectional view showing one embodiment of the plastic optical fiber unit of the present invention.

In a plastic optical fiber unit 10 shown in FIG. 1, four POF 4's are bundled in a longitudinal direction and integrated such that its cross-section has a square shape. The POF 4 is constituted of an optical fiber body 1 comprising a core 1a and a clad 1b, and a reinforcing layer 3 covering the outer circumference of the optical fiber body 1. A covering resin 6 is provided so as to cover the entire bundle of four POF 4's bundled in a longitudinal direction and integrated, and a cross-sectional shape of the plastic optical fiber unit 10 has a nearly circular form.

The plastic optical fiber unit 10 of the present invention has a relationship of 0.15≦T/D≦0.50 when thickness of the reinforcing layer 3 of the POF 4 coated is D and the shortest distance of from the POF 4 to the outer circumference of the plastic optical fiber unit 10 is T.

The reason that T/D is controlled to the above relationship is as follows.

Where the T/D is less than 0.15, the thickness of a coating resin 6 becomes too small, and when a lateral pressure or microbending has been applied to the plastic optical fiber unit 10 from the outside, the core 1a and the clad 1b, constituting the optical fiber body 1 deform, and as a result, transmission loss of the POF 4 is increased. Incidentally, 0.2≦T/D≦0.45 is more preferred.

Examples of a method of applying the coating resin 6 so as to cover the entire bundle of a plurality of the POF 4's include a method of supplying a coating resin (for example, a thermoplastic resin described below) from a resin extruder while feeding the bundle of POF 4's bundled in a longitudinal direction and integrated, from a feed machine, and shaping into a cable form (more specifically, a cable form having a cross-section of a nearly circular form), thereby collectively covering the bundle of POF 4's with the coating resin 6.

Further, for example, there is another method of applying an ultraviolet light-curable resin or an electron beam-curable resin so as to cover the entire bundle of POF 4's bundled in a longitudinal direction and integrated, and then curing the resin by ultraviolet light irradiation or electron beam irradiation, thereby applying the coating resin 6 so as to cover the entire bundle of the POF 4's. In place of applying an ultraviolet light-curable resin or an electron beam-curable resin, the bundle of POF 4's may be dipped in a solution containing the ultraviolet light-curable resin or the electron beam-curable resin.

Where the T/D exceeds 0.50, POF 4 deforms due to processing shrinkage of the coating resin 6 during the collective covering treatment, and transmission loss of the POF 4 may be increased. Furthermore, the POF 4 deforms by the heat during the extrusion processing of the coating resin 6, and transmission loss of the POF 4 may be increased. In the case of using an ultraviolet light-curable resin or an electron beam-curable resin as a precursor of the coating resin 6, the POF 4 may deform by the heat of crosslinking polymerization of those curable resins, and transmission loss of the POF 4 may be increased.

The individual constitution of the plastic optical fiber unit 10 of the present invention is described below.

The optical fiber body 1 may be any of a step index (SI) type and a graded index (GI) type. GI-POF is preferred in that it has high-speed and large-capacity transmission capability, and is therefore expected as an optical fiber in next-generation communications. Of the GI-POF, one having a structure that the optical fiber body comprises at least two clad layers and a refractive index of the outer circumferential clad layer is lower than that of an inner clad layer, that is, a structure that a refractive index of the clad layer is gradually decreased toward the outside, is particularly preferred.

Material of the POF 4 constituting the plastic optical fiber unit 10 is not particularly limited, and examples thereof include GI-POF in which the optical fiber body 1 comprises a fluorine resin and the reinforcing layer 3 comprises an acrylic resin (hereinafter referred to as a “fluorine resin-based POF”), and GI-POF in which in the optical fiber body 1, the core 1a comprises polymethylmethacrylate (PMMA) and the clad lb comprises a fluorine resin as constituent materials, and the reinforcing layer 3 comprises a thermoplastic resin (vinyl chloride or polyethylene). Of those, the fluorine resin-based POF is preferably used in that transmission loss is low and usable light wavelength region is wide.

Outer diameter of the POF 4 is preferably from 200 to 350 μm from the standpoint of reducing the diameter of a cable.

On the other hand, outer diameter of the plastic optical fiber unit 10 is preferably from 0.5 to 1.0 mm, and more preferably from 0.55 to 0.9 mm.

The number of the POF 4's constituting the plastic optical fiber unit 10 is not particularly limited, but is preferably from 3 to 7, and more preferably 4.

Material of the coating resin 6 is not particularly limited. For example, use can be made of a cured product of an ultraviolet light-curable resin, an electron beam-curable resin, or a thermoplastic resin such as low density polyethylene or soft vinyl chloride. Of those, an ultraviolet light-curable resin and an electron beam-curable resin are preferable for the reason that high precision control of a coating thickness is relatively easy. However, in the case of using an ultraviolet light-curable resin or an electron beam-curable resin as the coating resin 6, Young's modulus at ordinary temperature (23° C.) after curing is preferably from 90 to 1,000 MPa, more preferably from 200 to 900 MPa, and still more preferably from 600 to 900 MPa, for the reason of inhibition of peeling and breakage of the coating resin when the plastic optical fiber unit 10 has been bent small.

The plastic optical fiber unit 10 shown in FIG. 1 has a cross-section of nearly circular form, but the cross-section of the plastic optical fiber unit of the present invention is not limited to this form. For example, depending on the number of POF to be bundled, the cross-section of the plastic optical fiber unit 10 may be nearly elliptical form. For example, in the case that the number of POF to be bundled is 2, the plastic optical fiber unit 10 has a cross-section of nearly elliptical form.

Another embodiment of the plastic optical fiber unit of the present invention and application of the plastic optical fiber unit to a plastic optical fiber cable are described below.

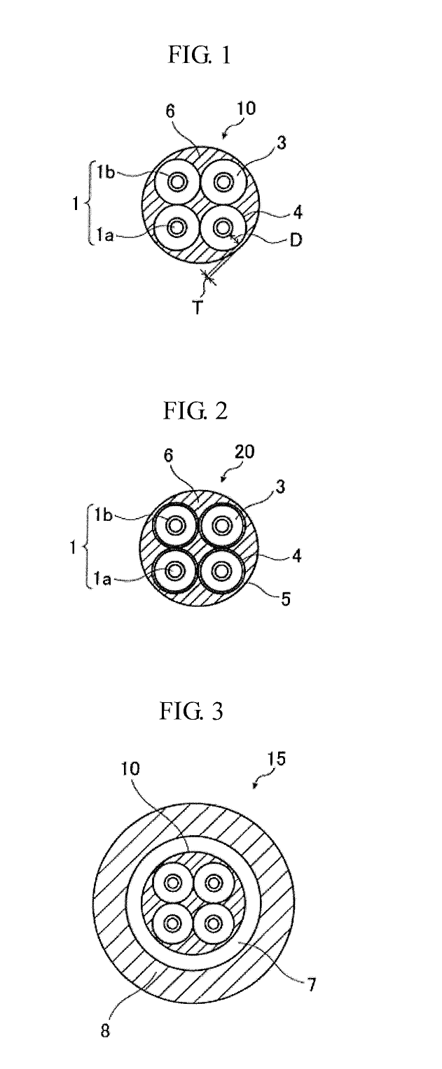

FIG. 2 is a cross-sectional view showing another embodiment of the plastic optical fiber unit of the present invention. The outer circumference of the POF 4 is colored by covering with a resin containing a pigment (a coloring layer 5 is formed) in order to differentiate the core wire in a plastic optical fiber unit 20 shown in FIG. 2. The plastic optical fiber unit 20 of the present invention shown in FIG. 2 is one produced by Example described below.

FIG. 3 is a cross-sectional view showing one embodiment of a plastic optical fiber cable using the plastic optical fiber unit of the present invention. The plastic optical fiber unit 10 shown in FIG. 1 is used in the plastic optical fiber cable 15 shown in FIG. 3.

The plastic optical fiber cable 15 of four-core cable is constituted by arranging a fiber tension member 7 on the circumference of the plastic optical fiber unit 10, and applying a tubular covering part 8 on the outer circumference of the fiber tension member 7.

As the fiber tension member 7 arranged on the circumference of the plastic optical fiber unit 10, use can be made of aramid fiber, polyethylene terephthalate (PET) fiber, carbon fiber, glass fiber, and the like. As the covering part 8 covered on the outer circumference of the fiber tension member 7, use can be made of polyvinyl chloride, flame-retardant polyethylene and the like, but it is not limited to those.

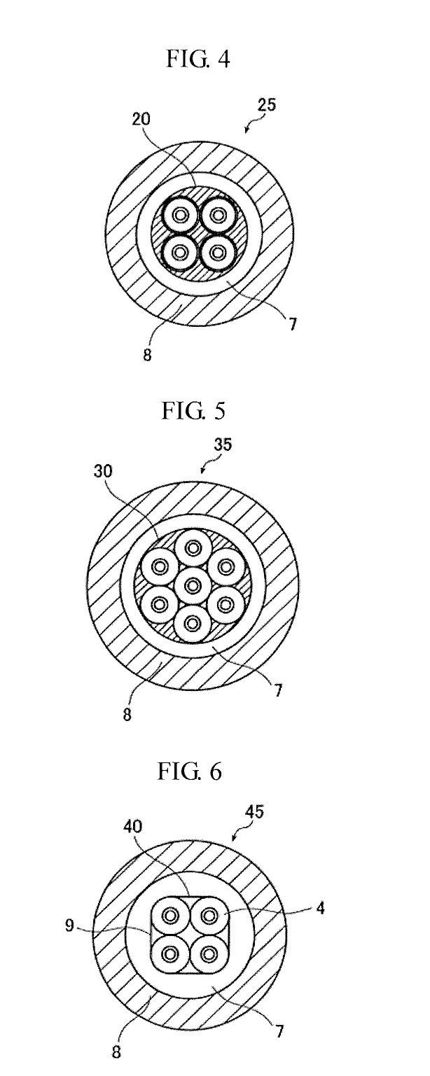

FIG. 4 is a cross-sectional view showing another embodiment of a plastic optical fiber cable using the plastic optical fiber unit of the present invention. The plastic optical fiber unit 20 shown in FIG. 2 is used in a plastic optical fiber cable 25 shown in FIG. 4. The plastic optical fiber cable 25 of the present invention shown in FIG. 4 is a cable produced by Example described below.

FIG. 5 is a cross-sectional view showing still another embodiment of the plastic optical fiber cable using the plastic optical fiber unit of the present invention.

A plastic optical fiber unit 30 in which the coating resin 6 is applied so as to cover the entire bundle of the POF 4's obtained by bundling seven POF 4's in a longitudinal direction and integrating those, more specifically the entire bundle of the POF 4's obtained by bundling seven POF 4's and integrating those such that one POF 4 is surrounded by the remaining six POF 4's, is used in the plastic optical fiber cable 35 shown in FIG. 5.

### EXAMPLE

Examples and comparative examples of the present invention are specifically described below.

### Example 1

The four-core plastic optical fiber cable 25 having the constitution as shown in FIG. 4 was produced using the following constituent materials. The plastic optical fiber unit 20 shown in FIG. 2 is used in the plastic optical fiber cable 25 shown in FIG. 4.

Graded index type fluorine resin-based POF (trade name: FONTEX manufactured by Asahi Glass Co., Ltd.) was used as POF 4. The optical fiber body 1 is that the core 1a has a diameter of 80 μm and the clad 1b has a diameter of 90 μm. The reinforcing layer 3 is formed by covering the outer circumference of the clad 1b with a polycarbonate resin such that the POF 4 has an outer diameter of 285 μm. The optical fiber body 1 has the numerical aperture (NA) of 0.245.

To make the core wire possible to be differentiated, coloration was conducted by covering the outer circumference of the fluorine resin-based POF 4 with an ultraviolet light-curable resin containing a pigment such that an outer diameter became 300 μm (the coloring layer 5 was formed). The color used is blue, yellow, green and white.

Four fluorine resin-based POF 4's each having the coloring layer 5 formed thereon were bundled as shown in FIG. 2, and the resulting bundle was collectively covered with an ultraviolet light-curable resin such that an outer diameter became 0.77 mm, thereby applying the coating resin 6 to the entire bundle of the POF 4's. Thus, the plastic optical fiber unit 20 was obtained.

In this case, the relationship between a thickness D of the reinforcing layer 3 and the shortest distance T of from the outer circumference of the POF 4 to the outer circumference of the plastic optical fiber unit 20 is T/D=0.420. The ultraviolet light-curable resin used has Young's modulus at ordinary temperature (23° C.) after curing of 890 MPa.

Aramid fibers (1270 dtex, two fibers were used) were arranged as the fiber tension member 7 on the circumference of the plastic optical fiber unit 20, and the outer circumference of the fiber tension member 7 was covered with a soft vinyl chloride resin such that an inner diameter became 1.0 mm and an outer diameter became 1.5 mm, thereby forming a tubular covering part 8. Thus, the plastic optical fiber cable 25 of four-core cable was produced.

### Example 2

The plastic optical fiber unit 20 was produced in the same manner as in Example 1 except that in the constitution of FIG. 4, four fluorine resin-based POF 4's were bundled as shown in FIG. 2, and the entire bundle was collectively covered with the same ultraviolet light-curable resin as used in Example 1 such that an outer diameter became 0.73 mm, and the plastic optical fiber cable 25 was produced.

In this case, the relationship between a thickness D of the reinforcing layer 3 and the shortest distance T of from the outer circumference of the POF 4 to the outer circumference of the plastic optical fiber unit 20 is T/D=0.215.

### Example 3

The plastic optical fiber unit 20 was produced in the same manner as in Example 1 except that in the constitution of FIG. 4, an ultraviolet light-curable resin having Young's modulus at ordinary temperature (23° C.) after curing of 90 MPa was used for collectively covering, and the plastic optical fiber cable 25 was produced.

### Example 4

The plastic optical fiber unit 20 was produced in the same manner as in Example 2 except that in the constitution of FIG. 4, an ultraviolet light-curable resin having Young's modulus at ordinary temperature (23° C.) after curing of 90 MPa was used for collectively covering, and the plastic optical fiber cable 25 was produced.

### Comparative Example 1

Four fluorine resin-based POF 4's having the same coloring layer 5 as in Example 1 formed thereon were bundled as shown in FIG. 6, and a PET tape 9 (width: 5 mm) was wound around the bundle. Thus, a plastic optical fiber unit 40 was obtained. The fiber tension member 7 was arranged on the outer circumference of the PET tape 9, and a tubular cover 8 was formed by soft vinyl chloride. Thus, a plastic optical fiber cable 45 was produced.

### Comparative Example 2

The plastic optical fiber cable 25 was produced in the same manner as in Example 1 except that in the constitution of FIG. 4, the collective covering was performed using a fluorine resin-based POF 4's having an outer diameter of 235 μm (the core 1a had a diameter of 80 μm, and the clad 1b had a diameter of 90 μm) such that an outer diameter became 0.65 mm.

In this case, the relationship between a thickness D of the reinforcing layer 3 and the shortest distance T of from the outer circumference of the POF 4 to the outer circumference of the plastic optical fiber unit 10 is T/D=0.565.

### Test Example

With respect to the plastic optical fiber units of Examples 1 to 4 and the plastic optical fiber units of Comparative Examples 1 and 2, lateral pressure characteristic and microbending characteristic were evaluated by the following procedures. Furthermore, with respect to the plastic optical fiber cables of Examples 1 to 4 and the plastic optical fiber cables of Comparative Examples 1 and 2, amount of loss change after cable production from a fiber strand was measured by a cutback method defined in JIS C-6823-2010.

Regarding the lateral pressure characteristic, a plastic optical fiber unit was placed between 100 mm metal flat plates, and the amount of loss change when a load of 50 N/100 mm was applied was measured.

Regarding the microbending characteristic, in the above lateral pressure measurement, an abrasive paper of #320 was adhered to the side contacting the plastic optical fiber unit of the flat plate, and the amount of loss change when a load of 50 N/100 mm was applied was measured.

Those results are shown in Table 1.

TABLE 1

| | Lateral pressure | Microbending | Amount of |
|---|---|---|---|
| | characteristic | characteristic | loss increase |
| | of plastic | of plastic | during cable |
| | optical fiber | optical fiber | production |
| | unit (dB) | unit (dB) | (dB/km) |
| Example 1 | 0 | 0.02 | 10 |
| Example 2 | 0.02 | 0.16 | 6 |
| Example 3 | 0.01 | 0.04 | 5 |
| Example 4 | 0.02 | 0.20 | 7 |
| Comparative | 0.13 | 0.87 | 100< |
| Example 1 | | | |
| Comparative | 0.09 | 0.31 | 65 |
| Example 2 | | | |

It is seen from the results of Table 1 that the plastic optical fiber units of Examples 1 to 4 satisfying 0.15≦T/D≦0.50 are improved in lateral pressure measurement and microbending characteristic as compared with the plastic optical fiber units of Comparative

Examples 1 and 2 that do not satisfy 0.15≦T/D≦0.50. As a result, in Examples 1 to 4, the amount of loss increase after cable production can be inhibited to low levels as compared with Comparative Examples 1 and 2.

Although the present invention has been described in detail and by reference to the specific embodiments, it is apparent to one skilled in the art that various modifications or changes can be made without departing the spirit and scope of the present invention.

This application is based on Japanese Patent Application No. 2010-204243 filed on Sep. 13, 2010, the disclosure of which is incorporated herein by reference.

### DESCRIPTION OF REFERENCE NUMERALS AND SIGNS

1: Optical fiber body
1a: Core
1b: Clad
3: Reinforcing layer
4: POF
5: Coloring layer
6: Coating resin
7: Fiber tension member
8: Covering part
9: PET tape
10, 20, 30, 40: Plastic optical fiber unit
15, 25, 35, 45: Plastic optical fiber cable

1. A plastic optical fiber unit in which a plurality of plastic optical fibers each comprising an optical fiber body and a reinforcing layer covering an outer circumference of the optical fiber body is bundled in a longitudinal direction and integrated, and a coating resin is applied so as to cover the entire bundle of the plastic optical fibers,
wherein the plastic optical fiber unit satisfies the relationship of 0.15≦T/D≦0.50 when a thickness of the reinforcing layer of the plastic optical fiber is D and a shortest distance of from the plastic optical fiber to the outer circumference of the plastic optical fiber unit is T.

2. The plastic optical fiber unit according to claim 1, wherein the coating resin is an ultraviolet light-curable resin or an electron beam-curable resin, and has Young's modulus at ordinary temperature (23° C.) after curing of from 90 to 1,000 MPa.

3. The plastic optical fiber unit according to claim 1, having a cross-section of nearly circular form or nearly elliptical form.

4. The plastic optical fiber unit according to claim 1, wherein the optical fiber body is a graded index type plastic optical fiber.

5. The plastic optical fiber unit according to claim 1, wherein the optical fiber body is a graded index type plastic optical fiber, the plastic optical fiber has at least two layers of clad layers, and a refractive index of an outer circumferential clad layer is lower than a refractive index of an inner clad layer.

6. A plastic optical fiber cable using the plastic optical fiber unit described in claim 1.
